(19) United States
(12) Patent Application Publication
(10) Pub. No.: US 2002/0088640 A1
(43) Pub. Date: Jul. 11, 2002

(54) Temperature sensor, leadwire and method

(76) Inventors: William C. Schuh, Delevan, WI (US); George Dexter Majewski, Elkhorn, WI (US); Arthur Orval Volbrecht, Genoa City, WI (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 09/756,894

(22) Filed: Jan. 9, 2001

(51) Int. Cl. H01B 7/08

(52) U.S. Cl. 174/117 M

(57) ABSTRACT

A thermocouple leadwire which is flat yet flexible, is provided with a woven overbraid connecting individually insulated single wires (singles) forming thermocouple pairs having differ. The overbraid keeps the singles substantially aligned and forms a substantially flat leadwire which is easily connected to a bracket on a wafer sensor and/or to one or more connectors for connecting the leadwire to a processor.

### FIELD OF THE INVENTION

This invention relates generally to a temperature sensor with a flexible leadwire and, more particularly, to the construction of the leadwire and method of its use with a temperature sensor such as a thermocouple.

### BACKGROUND OF THE INVENTION

Temperature sensors are used during the fabrication of semiconductors to help maintain uniform semiconductor wafer temperatures. In particular, uniform wafer temperature and its measurement and control minimize and/or eliminate abnormalities in the wafers and increase semiconductor fabrication yield.

One type of temperature sensor used to monitor wafer temperatures is a thermocouple, which generally is formed from two dissimilar metallic conductors joined at one point, called the hot junction, with the opposite ends connected to a voltmeter via leads joined at another point which is called the cold junction. When the two junctions are maintained at different temperatures, an electromotive force proportional to the temperature difference is induced. The temperature of the junction in or on a semiconductor wafer, for example, can be deduced from the thermoelectric potential or difference measured by the voltmeter (usually in millivolts), and the known properties of the metals used as conductors. Generally a processor is employed to convert the voltmeter readings into temperature readings.

Thermocouples or other temperature sensors embedded in or mounted to a semiconductor wafer are commonly referred to as wafer sensors. During the semiconductor manufacturing process, the wafer sensor may be carried on a conveyor through a furnace having multiple zones, each zone being separated from the others by curtains which leave a very small passage, perhaps only about seventy hundredths of an inch (about 1.8 millimeters) above the conveyor, through which the sensor must pass. In addition, the sensor passes completely through the furnace before it is retrieved, thereby necessitating a leadwire of at least about ten feet (about 3.5 meters).

### SUMMARY OF THE INVENTION

The present invention provides a thermocouple leadwire which is flat and flexible, as well as a wafer sensor having such a leadwire and a method of making and using the leadwire with the wafer sensor. Such construction is accomplished by providing a woven overbraid on top of individually insulated singles forming thermocouple pairs. The overbraid keeps the singles substantially aligned and forms a substantially flat leadwire which is easily connected to a bracket on the wafer sensor and/or to one or more connectors for connecting the leadwire to a processor.

More particularly, the present invention provides a thermocouple leadwire having a plurality of pairs of longitudinally extending, individually insulated wires disposed side-by-side, and a plurality of fiber strands braided around the individually insulated wires to provide a substantially flat configuration. The wires forming each pair of individually insulated wires are formed of different conductive materials.

According to one or more embodiments of the invention, the braided fiber strands separate the wire pairs, the braided fiber strands separate the wires of at least one of the pairs of thermocouple wires, the strands are selected from the group of metal wire or insulating fibers, the strands are stainless steel wire, the strands are fiberglass fibers, and/or the respective wires of each pair are tantalum and nickel, aluminum and nickel, platinum and palladium, or molybdenum and niobium. The thermocouple leadwire may include three pairs of individually insulated wires.

According to another aspect of the invention, a wafer sensor includes a semiconductor wafer, a temperature sensor mounted to the wafer, and a thermocouple leadwire connected to the temperature sensor. The leadwire has a plurality of pairs of longitudinally extending, individually insulated wires disposed side-by-side, and a plurality of fiber strands braided around the individually insulated wires to provide a substantially flat configuration. The wires forming each pair of individually insulated wires are formed of different conductive materials.

According to one or more embodiments of the invention, the temperature sensor is a thermocouple, a bracket is mounted to the wafer to connect the individual wires of the leadwire to the thermocouple, and/or a connector is attached to the distal end of each pair of wires for connecting the thermocouple sensor to a processor.

A method of making a thermocouple leadwire according to another aspect of the invention includes placing an insulation material around each of a plurality longitudinally extending individual wires, and braiding fiber strands around a plurality of individually insulated wires disposed side-by-side to provide a substantially flat configuration. The plurality of wires form a plurality of pairs with the wires of each pair being formed of different conductive materials.

According to yet another aspect of the invention, a wafer sensor system includes a semiconductor wafer, a temperature sensor mounted to the wafer, and a thermocouple leadwire connected to the temperature sensor. The leadwire has a plurality of pairs of longitudinally extending, individually insulated wires disposed side-by-side. The wires forming each pair of individually insulated wires are formed of different conductive materials. A plurality of fiber strands are braided around the individually insulated wires to provide a substantially flat configuration. A bracket is mounted to the wafer to connect the individual wires of the leadwire to the thermocouple. The system also includes a processor for processing the signal from the thermocouple and a connector attached to the distal end of each pair of wires for connecting the thermocouple sensor to a processor.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a schematic view of temperature measurement system including a wafer sensor and leadwire in accordance with the present invention.

FIG. 2 is an enlarged plan view of the attachment of the leadwire to the wafer sensor shown in FIG. 1.

FIG. 3 is a side view of the attachment of the leadwire to the wafer sensor shown in FIG. 2.

FIG. 4 is a schematic plan view of the leadwire of FIG. 1.

FIG. 5 is a cross-sectional view of the leadwire as shown on FIG. 4 at line 5-5.

FIG. 6 is a perspective view of a maypole braiding machine for making the leadwire of FIG. 1.

FIG. 7 is a perspective view of a portion of the braiding machine of FIG. 6 showing a top plate thereof.

FIG. 8 is a schematic top view of the top plate of the braiding machine of FIGS. 6 and 7.

### DETAILED DESCRIPTION

The present invention provides a thermocouple leadwire which is both flexible and has a low profile (i.e., is relatively flat compared to round or twisted multi-wire cables) for a system including a wafer sensor as described below in further detail.

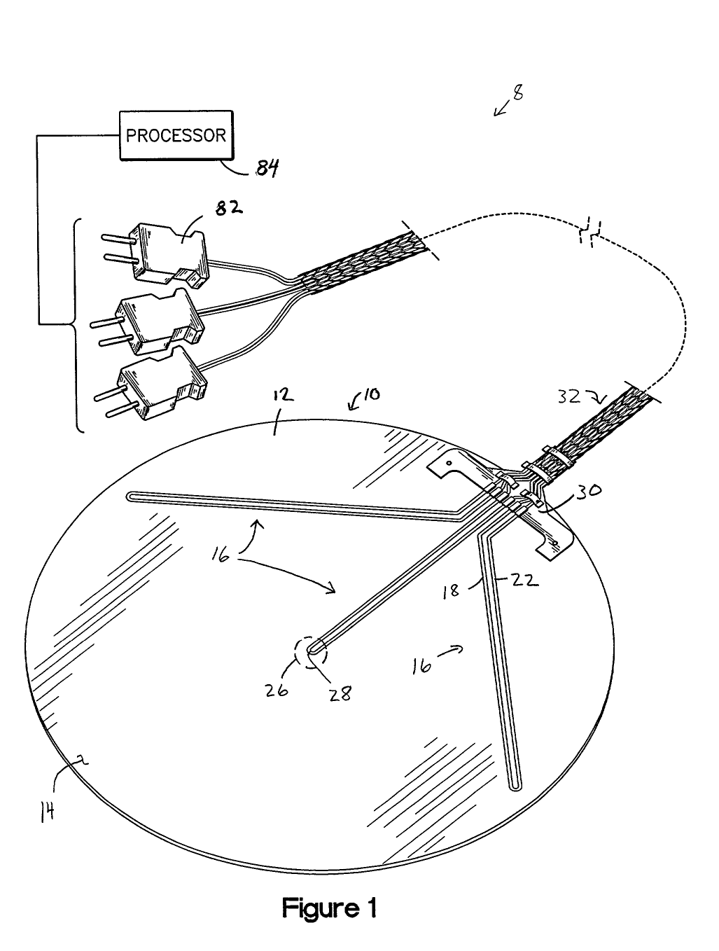

FIG. 1 is a perspective view of a system 8 which includes a temperature instrumented semiconductor wafer or wafer sensor 10 in accordance with the present invention. The wafer sensor includes a semiconductor substrate 12 having a top surface 14. The substrate may include other materials such as alumina, glass, ceramics, etc. A plurality of thermocouples 16 are formed or mounted on the top surface of the substrate.

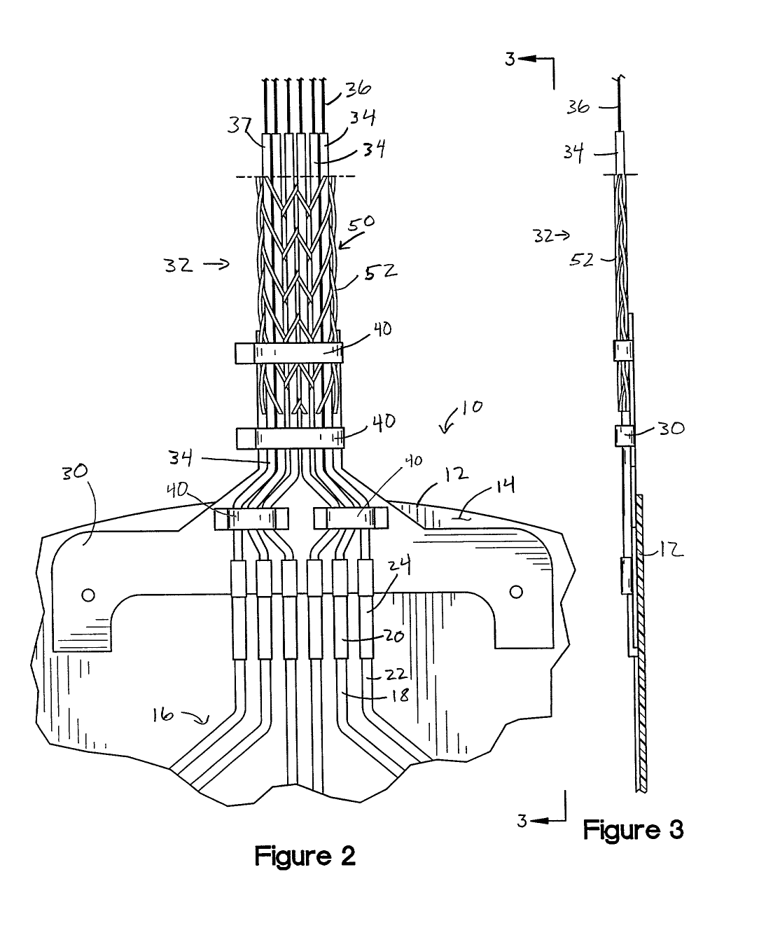

Each thermocouple 16 has a first conductive strip or conductor 18 which terminates at one end in a first bond pad 20 (FIG. 2). A second conductive strip or conductor 22 is laterally disposed from the first conductive strip and terminates at one end in a second bond pad 24 (FIG. 2). Both the first and second conductive strips 18 and 22 terminate at their opposite ends at region 26 where they overlap and come into electrical contact with one another to form a thermocouple junction 28. The other thermocouples may be identical in construction and form, differing only in their location on the wafer surface, although generally dispersed across the surface of the wafer. The first and second conductive strips or conductors are formed of dissimilar conductive materials.

In an exemplary embodiment of the invention, one of the conductors 18 is molybdenum and the other conductor 22 is niobium. Alternatively, the pairs of thermocouple conductors may be found of aluminum and nickel, or platinum and palladium, for example. Other dissimilar conductive materials may be used as the first and second conductors, such as, for example, rhodium, iron, aluminum, copper, iridium, molybdenum, nickel, niobium, palladium, platinum, tantalum, titanium, tungsten, gold and chromium in various combinations. Further, alloys and doped metals and other materials also may be used.

To minimize the complexity of the conversion circuitry, alloys and doped metals that have a consistent composition along their length generally are preferred. More preferably, the conductors 18 and 22 are pure metals since maintaining composition homogeneity in alloys can be challenging and the thermoelectric properties of alloys are strongly dependent upon their composition. Use of pure metals in both the conductors and any wires connected thereto also provides improved matching which also helps to minimize the complexity of the conversion circuitry which processes the thermocouple signal.

The wafer sensor 10 also includes a wafer connector fixture or bracket 30. The wafer connector fixture 30 is mounted to the semiconductor substrate 12. In the illustrated embodiment, the wafer connector fixture generally has a “Y” or “T” shape and is mounted to the top surface of the substrate adjacent an edge of the substrate, with the tail of the “Y” or “T” extending beyond the edge of the substrate. The wafer connector fixture holds a thermocouple leadwire 32 having a plurality of thermocouple wires or singles 34. Each thermocouple wire 34 includes a conductor 36 enclosed in an insulating sheath 37 (FIG. 2).

Referring now additionally to FIGS. 2 and 3, the wafer connector fixture 30 includes several tabs 40 which are folded over and secured to another portion of the wafer connector fixture to hold the leadwire 32, and more specifically, the plurality of individual thermocouple singles 34, in a fixed relationship with respect to the wafer substrate 12. Consequently, the wafer connector fixture provides improved durability and helps maintain operability of the wafer sensor during (and perhaps despite) operator handling.

Each thermocouple wire 34 is connected to a respective one of the conductive strips 18, 22 of the thermocouple 16. The leadwire 32 is electrically connected to each thermocouple 16 such that a first wire of each thermocouple pair is coupled to the first bond pad and a second wire of each thermocouple pair is coupled to the second bond pad of each thermocouple. The conductor 36 in each thermocouple wire is formed of a conductive material which is compatible with, and preferably identical to, the conductive material used to form the respective conductive strip 18, of the thermocouple to which the conductor is attached. Accordingly, the wires forming each thermocouple pair generally include conductors made of dissimilar materials.

Using the tabs 40 and extending the tail of the wafer connector fixture 30 off the substrate 12 allows the leadwire 32 to be secured to the fixture and thus to the substrate without substantially overlying the wafer. As a result, the temperature instrumented semiconductor wafer provided by the present invention eliminates thermocouple sheaths from significantly overlying the semiconductor wafer thereby providing additional usable space on the wafer and increasing the potential yield from the wafer. Combined with the substantially flat nature of the leadwire, the wafer connector fixture helps to provide a substantially flat yet durable junction between the leadwire and the wafer sensor (see FIG. 3).

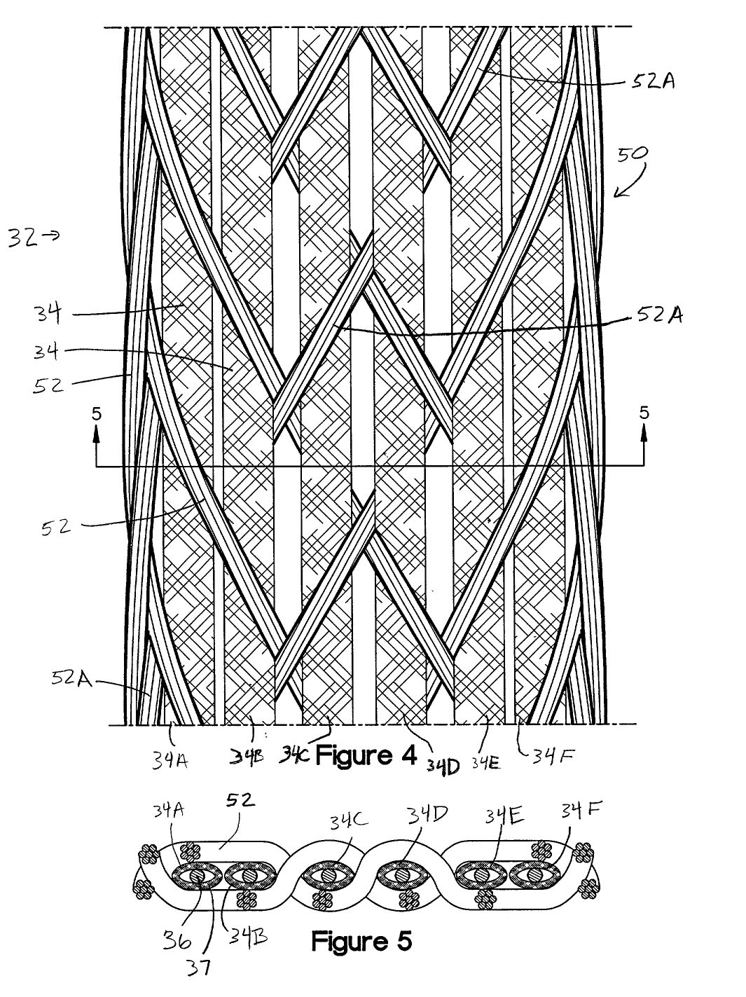

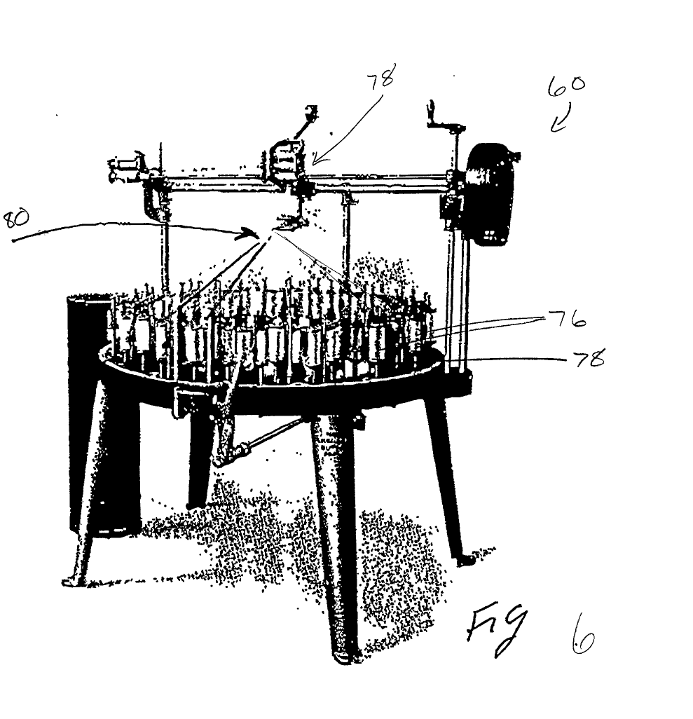

As shown in FIGS. 4 and 5, each thermocouple wire or single 34 includes a conductor 36 individually insulated with a sheath 37 formed in any known manner, such as with woven fiberglass. The thermocouple singles are grouped in thermocouple pairs of any number, for example three thermocouple pairs, and are joined together by an overbraid 50. For use with a wafer sensor, the material selected for the overbraid must be able to withstand the temperatures and processes encountered during use, such as in a furnace used in a semiconductor manufacturing process. The overbraid, also referred to as a multiplex ribbon braid, maintains the wires in a laterally adjacent and flat relationship without sacrificing the flexibility of the leadwire.

An exemplary overbraid 50 is formed of a plurality of fiber strands of metal wire (for example, stainless steel) or an insulating material (such as fiberglass). Each fiber strand may be formed of one or more fibers, and may form a ribbon. The strands are braided around the individually insulated singles 34 as is in a pattern which maintains the singles in a substantially flat configuration.

In the exemplary braid pattern illustrated in the figures, ten fiber strands 52 separate three pairs of individually insulated thermocouple singles 34. In FIGS. 4 and 5 the singles have been lettered 34A-34F to facilitate the following description. The fiber strands also separate the singles in the central pair, 34C and 34D, as the fiber strands bisect the leadwire 32.

Beginning from a lower left edge of the leadwire 32 shown in FIGS. 4 and 5, for example, an exemplary strand 52a extends along the side of the leadwire, passing under a strand coming over the leftmost single 34A, and under the leftmost pair of singles 34A and 34B, crossing over the leftmost of the central pair of singles 34C and under the rightmost single of the central pair 34D. The strand 52a then passes over the rightmost pair of singles 34E and 34F and up the right side of the leadwire, where it will pass over another strand, then under the next strand and back across the leadwire in the reverse pattern to that described above. As a result, the braided strands form a pattern that looks like a series of vertically stacked “W's” with a thicker group of strands running along the lateral sides of the leadwire. The “W” shape appears to be inverted on the reverse side of the leadwire, looking at the reverse of FIG. 4, for example.

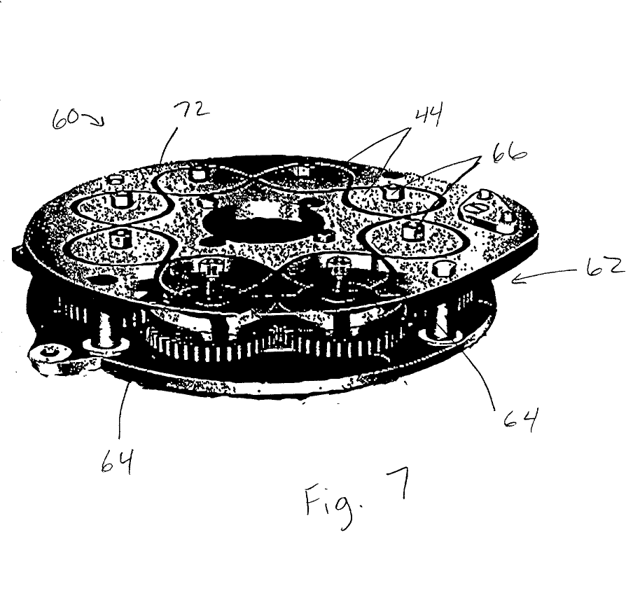

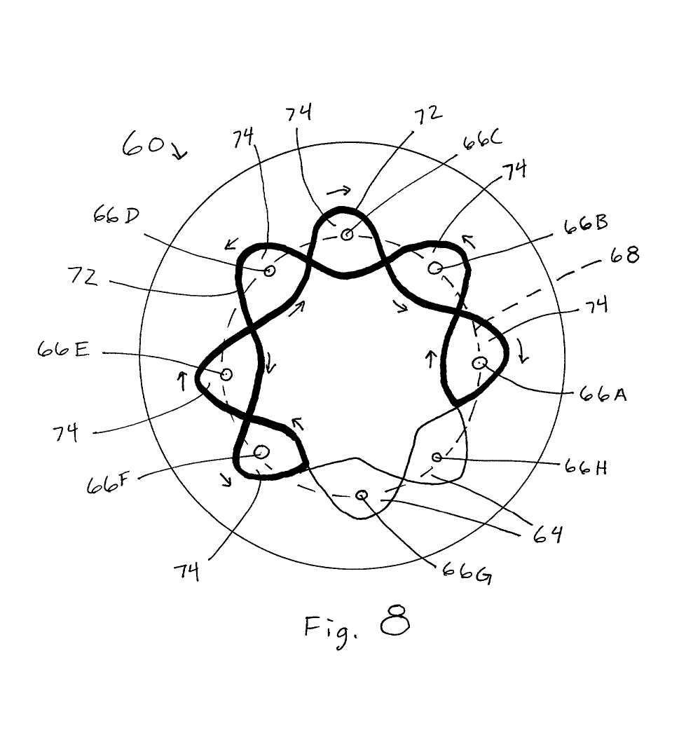

This overbraid may be constructed on a braiding machine or braider, such as on a sixteen carrier maypole braider. An exemplary braider 60 is manufactured by the New England Butt Company, and is shown in FIGS. 6 and 7. The braider preferably should be in the flat braid configuration with a Keleher gear set 62 and stop off quoits 64 with the conductors (in this case the thermocouple wires 34) brought up through the center of hollow quoit studs 66.

Referring to FIGS. 6-8 the quoit studs 66 are arranged in a circle 68 around the maypole braider 60 and material carriers 70 traverse a winding path or circuit 72 in and out and around the quoit studs as shown in FIG. 8. This path, or circuit, is formed by a series of oval openings arranged in a circle around the braider. The oval openings are partially filled by quoits 74, leaving a pair of crisscrossing sinuous grooves in which the material carriers travel.

Each carrier 70 has a stub (not shown) which extends through the groove and is moved or handed off from one gear to another as the gears 62 rotate, moving the carrier around the maypole circuit 72. The stop off quoits 64 completely fill the oval openings thereby blocking the path and breaking the circuit. The respective carriers 70 support spindles or bobbins 76 of strands of fibers or wire and as they crisscross each other they braid the strands onto the longitudinally movable thermocouple wires being pulled through the center of the studs. In this configuration the overbraid carriers braid around the thermocouple wires 34 but are stopped by the stop off quoits and shuttled back rather than completing the maypole circuit. See FIG. 8.

Since the studs 66 are arranged in a circle the degree of nonflatness is determined by how far around the circle the carriers 70 travel and how many studs are filled with thermocouple wires 34. To get a flatter construction with the same number of wires, multiple wires can be run through the same stud thus utilizing fewer of the studs 66 which in effect utilizes less of the circle. This is illustrated in FIG. 8 where some of the studs 66B and 66E have two wires which will become thermocouple wires 34A and 34B, and 34E and 34F (FIG. 4), respectively, some of the studs 66C and 66D have one wire which will become thermocouple wires 34C and 34D (FIG. 4), while some of the studs 66A and 66F are open or empty, and the studs 66G and 66H of the two stop off quoits 64 which break the circle 68 are closed.

Starting with the thermocouple conductors 36, these are insulated with one of several types of insulation either extruded or, for example, a fiberglass yarn braid consisting of 150-10-1 end S glass with a covering of twenty-one picks per inch forming an exemplary sheath 37 for each thermocouple wire or single 34. The maypole braider 60 may then be configured using a fifty-two top and forty-four bottom gear set to give a desired coverage of metal overbraid strands 52 such as four ends of 38 AWG stainless steel wire. Bobbins 76 (FIG. 6) of this material are placed on the carriers 70. The individual thermocouple wires 34 are fed through the various studs 66 and then brought up to a pull capstan 78. The carriers will then navigate the maypole circuit 72 while the wires are pulled through the studs to form the flat ribbon braid construction of the leadwire 32 (FIG. 4).

This type of braider 60 is better suited than warp and weft looms to form a flat braid by allowing a more continuous process while maintaining a flat as opposed to round construction. This construction also does not provide a complete coverage of the singles 34 with the overbraid 50, leaving some open space between the overbraid strands 52 as is apparent from FIG. 4, for example. As shown in FIG. 6, the strands 52 extending from the bobbins 76 on the overbraid carriers 70 form a cone 80. As more material is applied and more coverage attained the height of the cone lessens and increases the friction on the thermocouple wires 34, which can result in a less desirable leadwire. Furthermore, the degree of flatness of the braid can be altered by changing the number of quoit studs 66 filled with thermocouple singles. Alternative configurations and braiders can be used to braid the leadwire in accordance with the present invention.

In the final step of forming the leadwire, a connector 82 is coupled to the distal end of each thermocouple pair for electrically connecting the thermocouple junction 28 to a processor or conversion circuitry 84, as shown in FIG. 1. Alternatively, the plurality of thermocouple pairs may terminate into a parallel-type connector (not shown) for electrical communication to the conversion circuitry. The attachment of the leadwire 32 to a semiconductor wafer 12 also is facilitated by the present invention. The flat arrangement of the thermocouple wires 34 in the leadwire make it easier to separate individual wires for connection to individual thermocouple conductive strips 18 and 22 on the semiconductor wafer, and make it easier to visually separate the individual wires into thermocouple pairs for attaching connectors to the opposite ends.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. A thermocouple leadwire comprising a plurality of pairs of longitudinally extending, individually insulated wires disposed side-by-side, the wires forming each pair of individually insulated wires being formed of different conductive materials; and a plurality of fiber strands braided around the individually insulated wires to provide a substantially flat configuration.

2. A thermocouple leadwire as set forth in claim 1, wherein the braided fiber strands separate the wire pairs.

3. A thermocouple leadwire as set forth in claim 2, wherein the braided fiber strands separate the wires of at least one of the pairs of thermocouple wires.

4. A thermocouple leadwire as set forth in claim 1, wherein the strands are selected from the group of metal wire or insulating fibers.

5. A thermocouple leadwire as set forth in claim 4, wherein the strands are stainless steel wire.

6. A thermocouple leadwire as set forth in claim 4, wherein the strands are fiberglass fibers.

7. A thermocouple leadwire as set forth in claim 1, further comprising three pairs of individually insulated wires.

8. A thermocouple leadwire as set forth in claim 1, wherein one of the wires of each pair is molybdenum and the other wire of each pair is niobium.

9. A wafer sensor comprising a semiconductor wafer, a temperature sensor mounted to the wafer, and a thermocouple leadwire connected to the temperature sensor, the leadwire having a plurality of pairs of longitudinally extending, individually insulated wires disposed side-by-side, the wires forming each pair of individually insulated wires being formed of different conductive materials; and a plurality of fiber strands braided around the individually insulated wires to provide a substantially flat configuration.

10. A wafer sensor as set forth in claim 9, wherein the temperature sensor is a thermocouple.

11. A wafer sensor as set forth in claim 9, wherein a bracket is mounted to the wafer to connect the individual wires of the leadwire to the thermocouple.

12. A wafer sensor as set forth in claim 9, further comprising a connector attached to the distal end of each pair of wires for connecting the thermocouple sensor to a processor.

13. A method of making a thermocouple leadwire comprising:
placing an insulation material around each of a plurality longitudinally extending individual wires, the plurality of wires forming a plurality of pairs with the wires forming each pair being formed of different conductive materials;
braiding fiber strands around a plurality of individually insulated wires disposed side-by-side to provide a substantially flat configuration.

14. A wafer sensor system comprising a semiconductor wafer, a temperature sensor mounted to the wafer, and a thermocouple leadwire connected to the temperature sensor, the leadwire having a plurality of pairs of longitudinally extending, individually insulated wires disposed side-by-side, the wires forming each pair of individually insulated wires being formed of different conductive materials; a plurality of fiber strands braided around the individually insulated wires to provide a substantially flat configuration; a bracket mounted to the wafer to connect the individual wires of the leadwire to the thermocouple; a processor for processing the signal from the thermocouple; and a connector attached to the distal end of each pair of wires for connecting the thermocouple sensor to a processor.
